(19) United States
(12) Patent Application Publication
(10) Pub. No.: US 2025/0189777 A1
(43) Pub. Date: Jun. 12, 2025

(54) DUAL-CHANNEL LASER CONFOCAL MICROSCOPE SYSTEM FOR CROSSTALK ELIMINATION

(71) Applicant: Xidian University, Xi'an (CN)

(72) Inventors: Peng Gao, Xi’an (CN); Hongfei Suo, Xi’an (CN); Shaohui Huang, Xi’an (CN); Lan Yu, Xi’an (CN)

(21) Appl. No.: 18/970,971

(22) Filed: Dec. 6, 2024

(30) Foreign Application Priority Data
Dec. 6, 2023 (CN) 2023116660509

(51) Int. Cl. G02B 21/00; G01N 21/64

(52) U.S. Cl. CPC G02B 21/008; G01N 21/6458; G02B 21/0032; G02B 21/0036; G02B 21/0076

(57) ABSTRACT

A dual-channel laser confocal microscope system for crosstalk elimination is provided, which includes an illumination module, a scanning-imaging module, an acquisition module and a control and reconstruction module. The illumination module is configured to emit dual-wavelength parallel laser beams. The scanning-imaging module is configured to scan the to-be-tested sample point by point to excite and collect the fluorescence signal. The acquisition module is configured to separate the fluorescence signals into different acquisition channels and complete the optical signal acquisition. The control and reconstruction module is configured to control the pulse interleaved excitation of the illumination module and scanning imaging, and is also configured to decouple and reconstruct the fluorescence signals in the different acquisition channels to obtain confocal images without crosstalk for different wavelengths.

### CROSS-REFERENCE TO RELATED APPLICATION

This application claims priority to Chinese Patent Application No. 202311666050.9, filed on Dec. 6, 2023, which is herein incorporated by reference in its entirety.

### TECHNICAL FIELD

The disclosure relates to the field of microscopic imaging technologies, particularly to a dual-channel laser confocal microscope system for crosstalk elimination.

### BACKGROUND

Fluorescence microscopy has the advantages of little damage to biological samples and specific imaging, and is widely used in biomedicine, material chemistry, geology and other fields. An ordinary widefield fluorescence microscope uses parallel light to illuminate a fluorescent sample, so that the whole fluorescence sample is excited. Therefore, it has a poor longitudinal resolution of the fluorescence microscope. On the other hand, this way leads to severe photo-bleaching of fluorescent molecules in the fluorescence sample. Aiming at solving the above shortcomings of ordinary widefield fluorescence microscopy, three-dimensional optical microscopy imaging technologies were currently developed, mainly including light sheet fluorescence microscopy (LSFM), structured illumination microscopy (SIM), and laser scanning confocal microscopy (LSCM).

The LSFM is a microscopic imaging technique that can quickly perform three-dimensional information on a sample. It uses a sheet-like beam perpendicular to the imaging direction (hereinafter referred to as “light sheet”) to illuminate the sample, and only the sample within the focal plane corresponding to the light sheet is excited to emit fluorescence, and other out-of-focus areas are not affected, which can effectively avoid background noise.

The SIM is another commonly used three-dimensional imaging microscopy technique. This technique uses a fringe light field that the spatial light intensity follows a sinusoidal variation to illuminate the sample, and the unchanged defocus information can be eliminated through the fringe light field phase shifting, thereby leaving only a very thin portion of the sample illuminated by the light sheet.

The LSCM uses a focused light spot to scan a sample point by point and image. By introducing a pinhole (or replacing the pinhole with a single-mode optical fiber), defocused background noise is filtered, and thus a high-contrast image is obtained. Compared with the common widefield fluorescence microscopy, the LSCM effectively improves a signal-to-noise ratio of images and axial resolution of the optical system. A traditional multi-color LSCM system uses different fluorescent dyes or fluorescent proteins to label different components in biological sample, and uses different wavelengths of laser for illumination to realize multi-color confocal imaging. However, the sample is excited by laser with different wavelengths often leads to color-crosstalk between different detection channels. This is because the absorption spectrum of the fluorophore is always extended in the short wavelength direction, so that a short-wavelength laser can excite fluorescence in other channels at the same time. Meanwhile, if the sample are sequentially excited and scanned by the laser with different wavelengths to achieve dual-color imaging, the acquisition time will be doubled. The interaction information between two labeled subcellular organelles cannot be obtained at the same time either.

### SUMMARY

In order to solve the problem of color-crosstalk in the existing dual-channel confocal microscope system, the disclosure provides a dual-channel laser confocal microscope system for crosstalk elimination. The technical problems to be solved by the disclosure are realized by the following technical solutions.

An embodiment of the disclosure provides a dual-channel laser confocal microscope system for crosstalk elimination, which includes an illumination module, a scanning-imaging module, an acquisition module, and a control and reconstruction module. The illumination module, the scanning-imaging module and the acquisition module are sequentially coupled and connected in that order to form an optical system. The illumination module is configured to emit dual-wavelength parallel laser beams under control of the control and reconstruction module, the so-called dual-wavelength parallel laser beams are two parallel laser beams with different wavelengths, and laser pulses of the two parallel laser beams are interleaved with laser pulses of the other of the two parallel laser beams. The scanning-imaging module is configured to scan both of the dual-wavelength parallel laser beams moving in two orthogonal directions, converge the dual-wavelength parallel laser beams on a to-be-tested sample, perform point-by-point scanning on the to-be-tested sample to excite fluorescence signals, and collect the fluorescence signals. Once excited by the two-color excitation lights, the emitted fluorescence signals from the sample have two different bandwidths on wavelength, which often have a stokes-shift of tens of nanometers above their excitation wavelengths. The acquisition module is configured to separate the fluorescence signals into different acquisition channels of the acquisition module, respectively. The different acquisition channels are configured to: filter out excitation laser in the different acquisition channels to obtain the fluorescence signals, and eventually convert the fluorescence signals into electrical signals. The control and reconstruction module are configured to: generate two electronic pulse trains to control the illumination module to interleavely emit the laser pulses of the two parallel laser beams; regulate a scanning range and a scanning speed of the scanning-imaging module, decouple and reconstruct the fluorescence signals in the different acquisition channels of the acquisition module to obtain confocal images without crosstalk for the different wavelengths. The illumination module is configured to recognize the two electronic pulse trains.

In an embodiment of the disclosure, the control and reconstruction module include a host computer, a data acquisition card, a delay signal generator, and a time-correlated single photon counting (TCSPC) device. The host computer is configured to generate a digital signal containing delay information and transmit the digital signal containing the delay information to the data acquisition card. The data acquisition card is configured to transmit the digital signal containing the delay information to the delay signal generator. The delay signal generator is configured to generate a delay signal based on the digital signal containing the delay information and transmit the delay signal to the illumination module. The TCSPC device is configured to: record a total number of photons of the fluorescence signals, with the tag of absolute time and relative time of each of the photons. The absolute time represents incoming time of the photon relative to operating time of the dual-channel laser confocal microscope system in one measurement of the dual-channel laser confocal microscope system, and the relative time represents a time lag of the photon with the laser pulse previous to the photon. The host computer is further configured to: perform statistics on the time lag of each photon, to thereby yield fluorescence decay curves for each pixel in the different acquisition channels; separate the fluorescence decay curves in time series based on the different wavelengths; and reconstruct dual-channel confocal images without crosstalk for different wavelengths. Meanwhile, the TCSPC device also records the arrival time of the signals of X and Y scanners, with which all the photons can be restored to 2D spatial grids, forming a 2D-lifetime image for each channel.

In an embodiment of the disclosure, the illumination module includes a laser module, a first single-mode optical fiber, a first collimating lens, a first reflector, and a first dichroic mirror, which are sequentially arranged along a beam transmission direction of the illumination module. The laser module is connected to the delay signal generator and configured to emit dual-wavelength laser beams under control of the delay signal generator, and laser pulses of one of the dual-wavelength laser beams are interleaved with laser pulses of the other of the dual-wavelength laser beams. The first single-mode optical fiber is configured to couple the dual-wavelength laser beams to obtain coupled dual-wavelength laser beams. The first collimating lens is configured to collimate the coupled dual-wavelength laser beams to obtain collimated laser beams. The first reflector and the first dichroic mirror are configured to reflect the collimated laser beams to the scanning-imaging module to thereby obtain the dual-wavelength parallel laser beams.

In an embodiment of the disclosure, the scanning-imaging module includes a scanning galvanometer, a scanning lens, a second collimating lens, a second reflector, and an objective lens, which are sequentially arranged along a beam transmission direction of the scanning-imaging module. The scanning galvanometer is connected with the data acquisition card and receive the digital signal from the data acquisition card, and scan the dual-wavelength parallel laser beams from the illumination module in the two orthogonal directions. The scanning galvanometer includes two sub-reflectors arranged in parallel. The two sub-reflectors are configured to rotate under action of the digital signal to make both of the dual-wavelength parallel laser beams move in the two orthogonal directions within the sample. The scanning lens and the second collimating lens construct a telescope configuration, and the telescope configuration is configured to expand the dual-wavelength parallel laser beams from the scanning galvanometer to obtain expanded dual-wavelength parallel laser beams. The second reflector is configured to reflect the expanded dual-wavelength parallel laser beams emitted by the second collimating lens to the objective lens. The objective lens is configured to: converge the expanded dual-wavelength parallel laser beams on the to-be-tested sample, to scan the to-be-tested sample point by point and thereby to excite the fluorescence signals; and collect the fluorescence signals. An entrance pupil position of the scanning galvanometer is imaged to an entrance pupil position of the objective lens via the telescope configuration.

In an embodiment of the disclosure, wavelengths of the collimated laser beams are in a reflection band-pass wavelength range of the first dichroic mirror, and the collimated laser beams are reflected to the first dichroic mirror. The wavelength range of the fluorescence signals from the to-be-tested sample returned from the scanning-imaging module is not in the reflection band-pass wavelength range of the first dichroic mirror, and the fluorescence signals from the to-be-tested sample are transmitted from the first dichroic mirror to the acquisition module.

In an embodiment of the disclosure, the acquisition module includes a second dichroic mirror, a red acquisition channel and a green acquisition channel. The second dichroic mirror is disposed at a side of the first dichroic mirror opposite to the scanning galvanometer. The second dichroic mirror is configured to receive the fluorescence signals from the to-be-tested sample collected by the objective lens, and separate the fluorescence signals into a first wavelength fluorescence signal and a second wavelength fluorescence signal. The red acquisition channel is disposed in a transmission direction of the second dichroic mirror, and is configured to receive the first wavelength fluorescence signal and convert the first wavelength fluorescence signal into a first electrical signal. The green acquisition channel is disposed in a reflection direction of the second dichroic mirror, and is configured to receive the second wavelength fluorescence signal and convert the second wavelength fluorescence signal into a second electrical signal. The first wavelength fluorescence signal has a longer wavelength than the second wavelength fluorescence signal.

In an embodiment of the disclosure, the red acquisition channel includes a third reflector, a fourth reflector, a first adjustable optical filter, a first condenser lens, a second single-mode optical fiber, and a first detector, which are sequentially arranged along the transmission direction of the second dichroic mirror. The first adjustable optical filter is configured to filter out the excitation laser and the ambient light in the red acquisition channel. The first detector is configured to receive the first wavelength fluorescence signal in the red acquisition channel, convert the first wavelength fluorescence signal in the red acquisition channel into the first electrical signal, and transmit the first electrical signal to the host computer.

In an embodiment of the disclosure, the green acquisition channel includes a fifth reflector, a sixth reflector, a seventh reflector, a second adjustable optical filter, a second condenser lens, a third single-mode optical fiber, and a second detector, which are sequentially arranged along the reflection direction of the second dichroic mirror. The second adjustable optical filter is configured to filter out the excitation laser and the ambient light in the green acquisition channel. The second detector is configured to receive the second wavelength fluorescence signal in the green acquisition channel, convert the second wavelength fluorescence signal in the green acquisition channel into the second electrical signal, and transmit the second electrical signal to the host computer.

Compared with the related art, the disclosure has at least the following beneficial effects.
1. The dual-channel laser confocal microscope system of the disclosure can separate the laser beams with different wavelengths from each other in the time domain, that is, under the condition that a repetition frequency of pulses of two pulsed laser is fixed, by introducing a certain time delay to one of the two laser pulses, then separating and counting collected single photon data in a time channel. The color crosstalk that occurs when a fluorescence signal excited by the short-wavelength laser present in the red acquisition channel can be effectively avoided, thus further ensuring the accuracy and reliability of the synchronous imaging results of dual-color LSCM.
2. Compared with the traditional confocal microscope system, two kinds of subcellular organelles labeled with different fluorescent markers can be photographed at the same time, which has faster imaging speed and provides a powerful means for studying interaction between different subcellular organelles. Meanwhile, two-color lifetime imaging can be performed at the same time.

The disclosure will be described in further detail with reference to the accompanying drawings and embodiments.

### BRIEF DESCRIPTION OF DRAWINGS

FIG. 1 illustrates a schematic diagram of a dual-channel laser confocal microscope system for crosstalk elimination according to an embodiment of the disclosure.

FIG. 2 illustrates an optical system schematic diagram of a dual-channel laser confocal microscope system for crosstalk elimination according to an embodiment of the disclosure.

FIG. 3 illustrates a schematic diagram of wavelength ranges of adjustable optical filters in different channels of a dual-channel laser confocal microscope system for crosstalk elimination according to an embodiment of the disclosure.

FIG. 4 illustrates a schematic diagram of a de-crosstalk principle based on pulse interleaved excitation and time-correlated single-photon counting according to an embodiment of the disclosure.

FIG. 5A through FIG. 5F illustrate comparison views of confocal microscopy imaging grayscale image results for dual-color synchronous acquisition of wheat anther samples with and without the pulse interleaved excitation according to an embodiment of the disclosure.

### REFERENCE NUMERALS

101—Illumination module; 102—Scanning-imaging module; 103—Acquisition module; 104—Control and reconstruction module; 1—Host computer; 2—Data acquisition card; 3—Delay signal generator; 4—Laser module; 5—First single-mode optical fiber; 6—First collimating lens; 7—First reflector; 8—First dichroic mirror; 9—Scanning galvanometer; 10—Scanning lens; 11—Second collimating lens; 12—Second reflector; 13—Objective lens; 14—To-be-tested sample; 15—Second dichroic mirror; 16—Third reflector; 17—Fourth reflector; 18—First adjustable optical filter; 19—First condenser lens; 20—Second single-mode optical fiber; 21—First detector; 22—Fifth reflector; 23—Sixth reflector; 24—Seventh reflector; 25—Second adjustable optical filter; 26—Second condenser lens; 27—Third single-mode optical fiber; 28—Second detector; 29—Time-correlated single-photon counting device.

### DETAILED DESCRIPTION OF EMBODIMENTS

In order to further illustrate the technical means and effects adopted by the disclosure to achieve the predetermined disclosure purpose, a dual-channel laser confocal microscope system for eliminating crosstalk according to the disclosure will be described in detail with the accompanying drawings and specific embodiments.

The foregoing and other technical contents, features and effects of the disclosure can be clearly presented in the following detailed description of specific embodiments with the accompanying drawings. Through the description of the specific embodiments, a more in-depth and concrete understanding of the technical means and effects adopted by the disclosure to achieve the predetermined purpose can be obtained. However, the accompanying drawings are only for reference and explanation, and are not used to limit the technical solutions of the disclosure.

It should be noted that in this disclosure, relational terms such as first and second are merely used to distinguish one entity or operation from another entity or operation without necessarily requiring or implying any such actual relationship or order between these entities or operations. Moreover, the terms “including”, “containing” or any other variation are intended to cover non-exclusive inclusion, so that an article or equipment including a series of elements includes not only those elements, but also other elements not explicitly listed. Without more restrictions, an element defined by the phrase “including one” does not exclude that there are other identical elements in the article or equipment including the element.

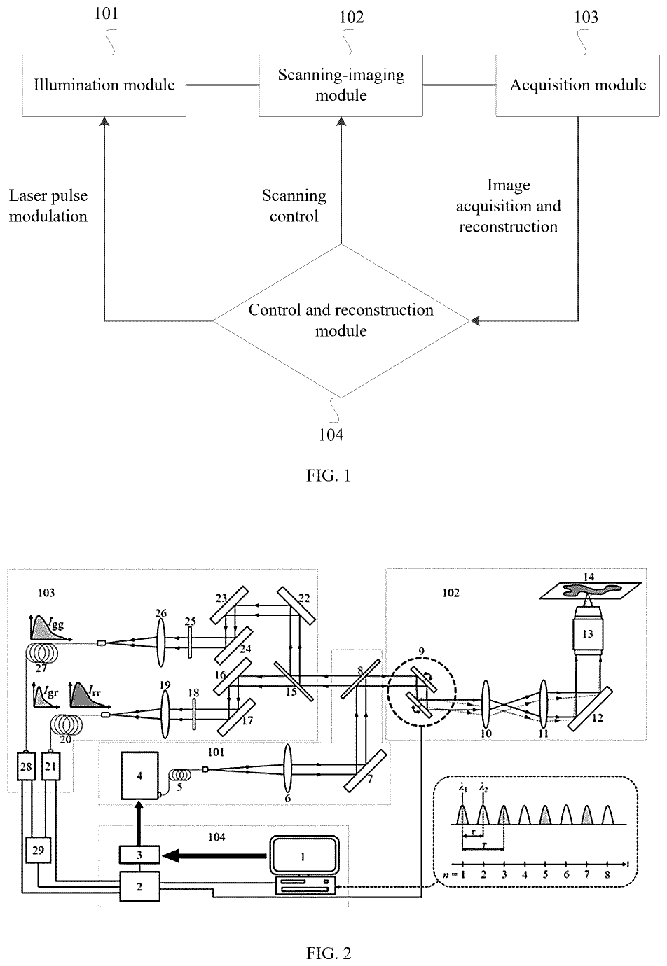

As illustrated in FIG. 1, FIG. 1 illustrates a schematic diagram of a dual-channel laser confocal microscope system for crosstalk elimination according to an embodiment of the disclosure. The dual-channel laser confocal microscope system includes an illumination module 101, a scanning-imaging module 102, an acquisition module 103, a control and reconstruction module 104. The illumination module 101, the scanning-imaging module 102 and the acquisition module 103 are sequentially coupled and connected in in that order to form an optical system. The control and reconstruction module 104 is configured to complete the control of various components in an optical path of the optical system, signal reading and image reconstruction processing. The illumination module 101 is configured to emit dual-wavelength parallel laser beams under control of the control and reconstruction module 104, the dual-wavelength parallel laser beams are two parallel laser beams with different wavelengths, and laser pulses of one of the two parallel laser beams are interleaved with laser pulses of the other one of the two parallel laser beams. The scanning-imaging module 102 is configured to: make both of the dual-wavelength parallel laser beams move in two orthogonal directions, converge the dual-wavelength parallel laser beams on a to-be-tested sample 14, perform point-by-point scanning on the to-be-tested sample 14 to excite fluorescence signals from the to-be-tested sample 14, and collect the fluorescence signals; and the fluorescence signals have two different bandwidths on wavelength. The acquisition module 103 is configured to separate the fluorescence signals and guide the fluorescence signals into different acquisition channels of the acquisition module 103, respectively, the different acquisition channels are configured to: filter out excitation laser in the different acquisition channels to obtain the fluorescence signals, and eventually convert the fluorescence signals into electrical signals. The control and reconstruction module 104 is configured to: generate two electronic pulse trains to control two different wavelength laser of the illumination module 101 in an interleaved manner; regulate a scanning range and a scanning speed of the scanning-imaging module 102, then decouple and reconstruct the fluorescence signals in different acquisition channels of the acquisition module 103 to obtain confocal images without crosstalk for different wavelengths, and wherein the illumination module 101 is further configured to recognize the two electronic pulse trains.

Specifically, as illustrated in FIG. 2, FIG. 2 illustrates an optical path diagram of a dual-channel laser confocal microscope system for crosstalk elimination according to an embodiment of the disclosure. The control and reconstruction module 104 includes a host computer 1, a data acquisition card 2, a delay signal generator 3 and a time-related single photon counting (TCSPC) device 29. The host computer 1 is configured to generate a digital signal containing delay information and transmit the digital signal containing the delay information to the data acquisition card 2. The data acquisition card 2 is configured to transmit the digital signal containing the delay information to the delay signal generator 3. The delay signal generator 3 is configured to generate a delay signal based on the digital signal containing the delay information and transmit the delay signal to the illumination module 101. The TCSPC device 29 is configured to: record a total number of photons of the fluorescence signals, and record absolute time and relative time of each of photons. The absolute time represents incoming time of the photon relative to operating time of the dual-channel laser confocal microscope system in one measurement of the dual-channel laser confocal microscope system, and the relative time represents a time lag of the photon with the laser pulse previous to the photon. The host computer 1 is further configured to: perform statistics on the time lag of each photon, to thereby yield fluorescence decay curves, which is in turn governed by the radiation transition of the fluorescence signals. The fluorescence decay curves are obtained for each pixel in two separate color channels, and two confocal images without crosstalk can be obtained by filtering out crosstalk signals that are excited by the other excitation light.

In an embodiment, the illumination module 101 includes a laser module 4, a first single-mode optical fiber 5, a first collimating lens 6, a first reflector 7, and a first dichroic mirror 8, which are sequentially arranged along a beam propagation direction of the illumination module 101. The laser module 4 is connected with the delay signal generator 3 and is configured to emit dual-wavelength laser beams under control of the delay signal generator 3, and laser pulses of one of the dual-wavelength laser beams are interleaved with laser pulses of the other of the dual-wavelength laser beams. The first single-mode optical fiber 5 is configured to couple the dual-wavelength laser beams to obtain coupled dual-wavelength laser beams. The first collimating lens 6 is configured to collimate the coupled dual-wavelength laser beams to obtain collimated laser beams. The first reflector 7 and the first dichroic mirror 8 are configured to reflect the collimated laser beams to the scanning-imaging module 102, and to thereby obtain the dual-wavelength parallel laser beams.

In an embodiment, a focal length of the collimating lens 6 is f=150 mm.

Specifically, the host computer 1 is configured to generate the digital signal containing delay information and transmit the digital signal to the data acquisition card 2. In an embodiment, the host computer 1 can also be replaced by a signal generator, and a delay signal generated by the data acquisition card 2 directly acts on the laser module 4, so that the laser module 4 can emit two laser with different wavelengths in a visible light band and keep a constant time difference between laser pulses of the two laser, thus realizing interleaved excitation of the two laser with two wavelengths in the time domain. On the other hand, the fluorescence signals of the to-be-tested sample collected by the time-correlated single photon counting device 29 from the acquisition module 103 can be counted in the form of photons. Then, the host computer 1 records a time lag between each of the photons and a laser pulse previous to each of the photon, and performs statistics on the time lag of each photon, to thereby yield fluorescence decay curves, which is in turn governed by the radiation transition of the used fluorophores. The fluorescence decay curves are obtained for each pixel in two separate color channels, and two confocal images without crosstalk can be obtained by filtering out the crosstalk signals that are excited by wrong excitation light.

In an embodiment, the scanning-imaging module 102 includes a scanning galvanometer 9, a scanning lens 10, a second collimating lens 11, a second reflector 12 and an objective lens 13, which are sequentially arranged along a beam transmission direction of the scanning-imaging module 102. The scanning galvanometer 9 is connected with the data acquisition card 2 and is configured to receive the digital signal from the data acquisition card 2. The scanning galvanometer 9 includes two sub-reflectors arranged in parallel, and these sub-reflectors can rotate under action of the digital signal to make both of the dual-wavelength parallel laser beams move in the two orthogonal directions under rotation of the two sub-reflectors. The scanning lens 10 and the second collimating lens 11 construct a telescope configuration, and the telescope configuration is configured to expand the dual-wavelength parallel laser beams from the scanning galvanometer 9 to obtain expanded dual-wavelength parallel laser beams. The second reflector 12 is configured to reflect the expanded dual-wavelength parallel laser beams emitted by the second collimating lens 11 to the objective lens 13. The objective lens 13 is configured to: converge the expanded dual-wavelength parallel laser beams on the to-be-tested sample 14, to scan the to-be-tested sample 14 point by point and thereby to excite the fluorescence signals from the to-be-tested sample 14; and collect the fluorescence signals. An entrance pupil position of the scanning galvanometer 9 is imaged to an entrance pupil position of the objective lens 13 via the telescope configuration.

It should be noted that wavelengths of the collimated laser beams are in a reflection band-pass wavelength range of the first dichroic mirror 8, so that the collimated laser beams are reflected to the first dichroic mirror 8; and wavelengths of the fluorescence signals from the to-be-tested sample 14 returned from the scanning-imaging module 102 are not in the reflection band-pass wavelength range of the first dichroic mirror 8, and the fluorescence signals from the to-be-tested sample 14 are transmitted from the first dichroic mirror 8 to the acquisition module 103.

In an embodiment, a focal length of the scanning lens 10 is f=70 mm. The objective lens 13 is an oil-immersed objective lens with a numerical aperture of 1.4.

In an embodiment, the acquisition module 103 includes a second dichroic mirror 15, a red acquisition channel and a green acquisition channel. The second dichroic mirror 15 is disposed at a side of the first dichroic mirror 8 facing away from the scanning galvanometer 9; and the second dichroic mirror 15 is configured to receive the fluorescence signals from the to-be-tested sample 14 collected by the objective lens 13, and separate the fluorescence signals into a first wavelength fluorescence signal and a second wavelength fluorescence signal. The red acquisition channel is disposed in a transmission direction of the second dichroic mirror 15, and is configured to receive the first wavelength fluorescence signal and convert the first wavelength fluorescence signal into a first electrical signal. The green acquisition channel is disposed in a reflection direction of the second dichroic mirror 15, and is configured to receive the second wavelength fluorescence signal and convert the second wavelength fluorescence signal into a second electrical signal. A wavelength of the first wavelength fluorescence signal is longer than a wavelength of the second wavelength fluorescence signal.

In an embodiment, the red acquisition channel includes a third reflector 16, a fourth reflector 17, a first adjustable optical filter 18, a first condenser lens 19, a second single-mode optical fiber 20 and a first detector 21, which are sequentially arranged along the transmission direction of the second dichroic mirror 15. The first adjustable optical filter 18 is configured to filter out the excitation laser in the red acquisition channel. The first detector 21 is configured to receive the first wavelength fluorescence signal in the red acquisition channel, convert the first wavelength fluorescence signal in the red acquisition channel into the first electrical signal, and transmit the first electrical signal to the host computer 1.

In an embodiment, the green acquisition channel includes a fifth reflector 22, a sixth reflector 23, a seventh reflector 24, a second adjustable optical filter 25, a second condenser lens 26, a third single-mode optical fiber 27 and a second detector 28, which are sequentially arranged along the reflection direction of the second dichroic mirror 15. The second adjustable optical filter 25 is configured to filter out the excitation laser in the green acquisition channel. The second detector 28 is configured to receive the second wavelength fluorescence signal in the green acquisition channel, convert the second wavelength fluorescence signal in the green acquisition channel into the second electrical signal, and transmit the second electrical signal to the host computer 1.

In an embodiment, focal lengths of the first condenser lens 19 and the first condenser lens 26 are both f=125 mm.

In this embodiment, using the band-pass and band-stop characteristics of the second dichroic mirror 15, the fluorescence signals in a reflection loop are separated into two paths: the first wavelength fluorescence signal (longer wavelength) and the second wavelength fluorescence signal (shorter wavelength), and the first wavelength fluorescence signal (longer wavelength) and the second wavelength fluorescence signal (shorter wavelength) are respectively transmitted to the red acquisition channel (longer wavelength channel) and reflect to the green acquisition channel (shorter wavelength channel). The adjustable optical filters (the first adjustable optical filter 18 and the second adjustable optical filter 25) in the two acquisition channels filter out optical signals with wavelengths that do not belong to the bands of the fluorescence signals generated by exciting the to-be-tested sample 14 to thereby obtain the fluorescence signals, and then the fluorescence signals are focused and coupled into the corresponding single-mode optical fiber (the second single-mode optical fiber 20/the third single-mode optical fiber 27) through the corresponding condenser lens (the first condenser lens 19/the second condenser lens 26). Then the effective optical signals (i.e., the fluorescence signals) are transmitted to the corresponding detectors (the first detector 21/the second detector 28), and finally the collected optical signals are converted into electrical signals and transmitted to the host computer 1 for imaging or related data calculation. The adjustable optical filters in the two optical paths can be switched according to specific fluorescence emission wavelengths.

In practice, firstly, the digital signal containing delay information is set and generated in a user program of the host computer 1, and the host computer 1 transmits the digital signal containing the delay information to the data acquisition card 2. A laser pulse frequency of a laser pulse used in this embodiment is 40 MHz (a corresponding pulse period is 25 ns), and a set time delay is 12.5 ns. Then, the digital signal is converted into a corresponding analog electrical signal by the data acquisition card 2 and the analog electrical signal is distributed by the data acquisition card 2 to the delay signal generator 3. After receiving the analog electrical signal sent by the delay signal generator 3, the laser module 4 can emit dual-wavelength laser beams with mutually interleaved pulses in time sequence. The laser module 4 used in this embodiment contains four laser with different wavelengths, the wavelengths of which are 405 nm, 470 nm, 561 nm and 637 nm respectively, and the working wavelengths of the two laser beams selected herein are 470 nm and 561 nm respectively, that is to say, the dual-wavelength laser beams emitted by the laser module 4 contain laser beams with two working wavelengths of 470 nm and 561 nm respectively.

Subsequently, the pulse-interleaved dual-wavelength laser beams are introduced into an optical path as illumination beams through the first single-mode optical fiber 5, the pulse-interleaved dual-wavelength laser beams are collimated into parallel laser beams (i.e., collimated laser beams) by the collimating lens 6 with a focal length of f=150 mm, and then the collimated laser beams are reflected to the first dichroic mirror 8 by the first reflector 7. A reflection band-pass wavelength range of the first dichroic mirror 8 in this embodiment is 370 nm to 410 nm, 470 nm to 491 nm, 530.5 nm to 533.5 nm, and 632.8 nm to 647.1 nm, and corresponding reflectance of these four bands are all above 94%, so that laser beams with wavelengths of 470 nm and 561 nm are reflected into the scanning galvanometer 9. In an initial state, the two sub-reflectors of the scanning galvanometer 9 are parallel to each other and form a predetermined angle with an optical axis to form a two-dimensional scanning galvanometer. After the scanning galvanometer 9 receives a control signal sent by the data acquisition card 2, the incident parallel laser beams can be deflected in two orthogonal directions through the rotation of the sub-reflectors.

The scanning lens 10 and the collimating lens 11 arranged behind the scanning galvanometer 9 together construct a telescope configuration, and a relative positional relationship among the scanning galvanometer 9, the scanning lens 10 and the collimating lens 11 can make the dual-wavelength parallel laser beams emitted from the scanning galvanometer 9 be imaged at an entrance pupil position of the objective lens 13 conjugated with the scanning galvanometer 9 in a spatial position, so as to ensure that an intensity of a focused spot of the dual-wavelength parallel laser beams passing through the objective lens 13 at different incident angles is constant, and at the same time, the dual-wavelength parallel laser beams can be expanded. The expanded dual-wavelength parallel laser beams are focused on a specific position on the to-be-tested sample 14 by the objective lens 13, and the fluorescence signals are excited and collected by the objective lens 13, and the point-by-point detection of the to-be-tested sample 14 is realized in cooperation with the scanning galvanometer 9. The fluorescence signals and stray optical signals (referred to as hereinafter returned optical signals) collected by the objective lens 13 return to the first dichroic mirror 8 along the original optical path in the scanning-imaging module 102. Due to the Stokes shift effect, wavelength of the fluorescence signal will increase by 20-50 nm compared with wavelengths of excitation laser, so the returned optical signals can transmit through the first dichroic mirror 8.

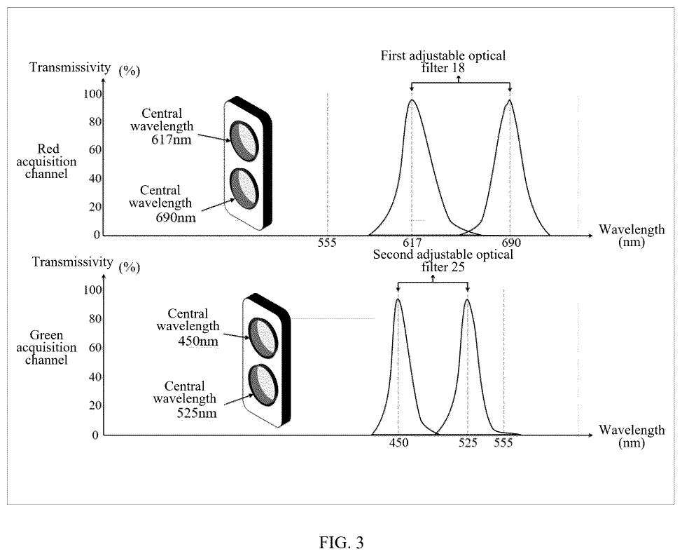

Then, the fluorescence signals are divided and input into two branches: the red acquisition channel and the green acquisition channel at the second dichroic mirror 15. A reflectivity of the second dichroic mirror 15 for visible light with a wavelength range of 350 nm-547.5 nm is greater than 98%, and a transmittance of the second dichroic mirror 15 for visible light with a wavelength range of 562.5 nm-745 nm is greater than 93%. The returned optical signals take a wavelength of 555 nm as the boundary point. The returned optical signals are divided into two paths which are larger or smaller than this wavelength. Details of transmission and reflection are illustrated in FIG. 3. Schematic views with respect to the red acquisition channel and the green acquisition channel in the upper and lower portions in FIG. 3 correspond to the transmission part and the reflection part of the second dichroic mirror 15, respectively. An adjustable optical filter is in each of the two acquisition channels to filter the stray optical signals. As illustrated in FIG. 3, the first adjustable optical filter 18 in the red acquisition channel includes two filters, and their central wavelengths and full widths at half maximum (FWHM) (that is, the corresponding wavelength range when the transmittance or reflectivity is reduced to half of the maximum value) are 617 nm/73 nm and 690 nm/40 nm respectively. In this embodiment, the former is selected, that is to say, the filter with central wavelength and FWHM of 617 nm/73 nm is selected. The second adjustable optical filter 25 in the green acquisition channel includes two filters, their central wavelengths and full widths at half maximum are 450 nm/50 nm and 525 nm/45 nm respectively. In this embodiment, the latter is selected in this embodiment, that is, the filter with central wavelength and full width at half maximum of 525 nm/45 nm is selected. After that, the fluorescence signal of each acquisition channel is focused by the first condenser lens 19 or the first condenser lens 26 in the corresponding acquisition channel, coupled and introduced into a corresponding single-mode optical fiber (the second single-mode optical fiber 20 or the third single-mode optical fiber 27), and is transmitted to a corresponding detector (the first detector 21 or the second detector 28), so that the acquisition of two dual-wavelength signals is completed. In this embodiment, both the first detector 21 and the second detector 28 are avalanche photodiode detectors, which have extremely high sensitivity response to a single photon.

Further, the first detector 21 and the second detector 28 convert the collected fluorescence signals into electrical signals and send the electrical signals to the time-correlated single photon counting device 29. The time-correlated single photon counting device 29 can accurately record the time interval (i.e., the time difference) between the photon arrival and the excitation laser pulse, of which the statistical results yield a fluorescence decay curve in the time domain.

In this embodiment, the time delay introduced between laser pulses with two wavelengths is 12.5 ns, and a dwell time of the focused laser spot in each pixel is 30 μs.

In actual operation, the first adjustable optical filter 18 and the second adjustable optical filter 25 in the dual-channel laser confocal microscope system are switched according to the working wavelengths of the laser beams. An appropriate amount of objective oil is dropped on the objective lens 13 to completely coat a surface of the objective lens 13, and the to-be-tested sample 14 is placed in an appropriate position. A position of the to-be-tested sample 14 is adjusted laterally and the to-be-tested sample 14 is axially moved, so that a focus of illumination light is located at a center of the to-be-tested sample 14 in a thickness direction of the to-be-tested sample 14, so that sample information of the to-be-tested sample can be clearly seen in a microscope eyepiece. Then, time delay of 12.5 ns applied in two laser pulses with different wavelengths is input into a control interface of the host computer 1, and a digital signal is transmitted to the delay signal generator 3 through the data acquisition card 2. The delay signal generator 3 converts the digital signal into a digital electrical signal that can be recognized by a laser, and transmits the digital electrical signal to two pulsed laser with wavelengths of 470 nm and 561 nm. The two pulsed laser emit two common-channel laser with different wavelengths and interleaved laser pulses. Then, parameters related to a scanning range and a scanning speed are input into the control interface of the host computer 1, and the scanning galvanometer 9 is controlled to complete the point-by-point excitation and fluorescence signal collection of the to-be-tested sample 14. After photoelectric signals are conducted in the dual-channel laser confocal microscope system, a photon number and corresponding time information at different spatial points can be finally obtained at the host computer 1, and a crosstalk-removed two-color confocal image can be obtained by reassigning the photons according to the information of the color channel, the absolute time, and the relative time.

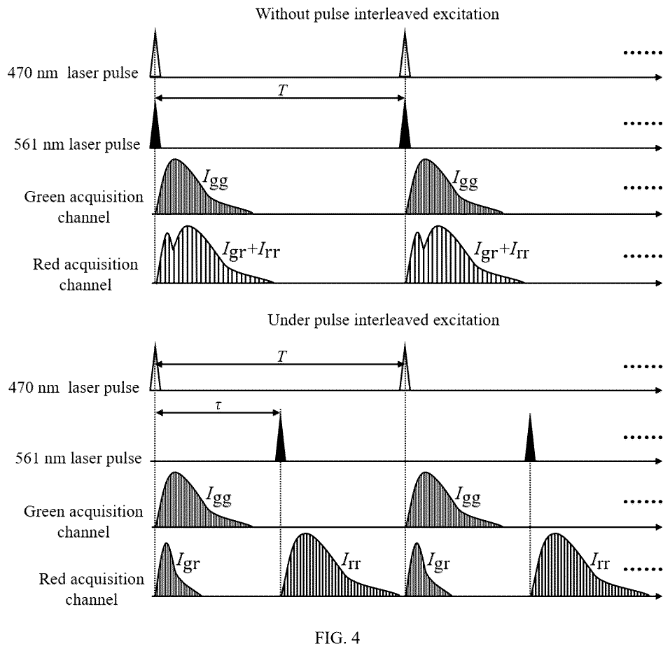

As illustrated in FIG. 4, FIG. 4 illustrates a schematic diagram of a de-crosstalk principle based on pulse interleaved excitation and time-correlated single-photon counting according to an embodiment of the disclosure. When pulse interleaved excitation is not used, the laser pulses with wavelengths of 470 nm and 561 nm are completely coincident in time sequence, and the fluorescence signals sequentially excited by the laser pulses with the wavelength of 470 nm are expressed as Igg in the green acquisition channel. Because an excitation spectrum of fluorescent dye or fluorescent protein is broad and much extended to the short wavelength direction, red fluorescence will be simultaneously excited by the red and green laser pulses, and both are collected in the red acquisition channel. As such, the fluorescence signals received in the red acquisition channel are the superposition of fluorescence signals excited by two lasers with two wavelengths, that is, Igr+Irr. When pulse interleaved excitation is used, a time delay τ is introduced between the two laser pulses, that is, an arrival time interval between adjacent laser pulses between two lasers with different wavelengths is τ, so that the fluorescence signals Irr and Igr excited by the laser with different wavelengths in the red acquisition channel can be separated, and T is a pulse period of the laser. The above photon data (the information of the color channel, the absolute time, and the relative time) are transmitted back to the data acquisition card 2, and then the photons collected by each spatial pixel point are separated and reconstructed at the host computer 1, so as to realize the separation of fluorescence signals in different bandwidths, which can effectively solve the color crosstalk problem in two-color confocal synchronous imaging.

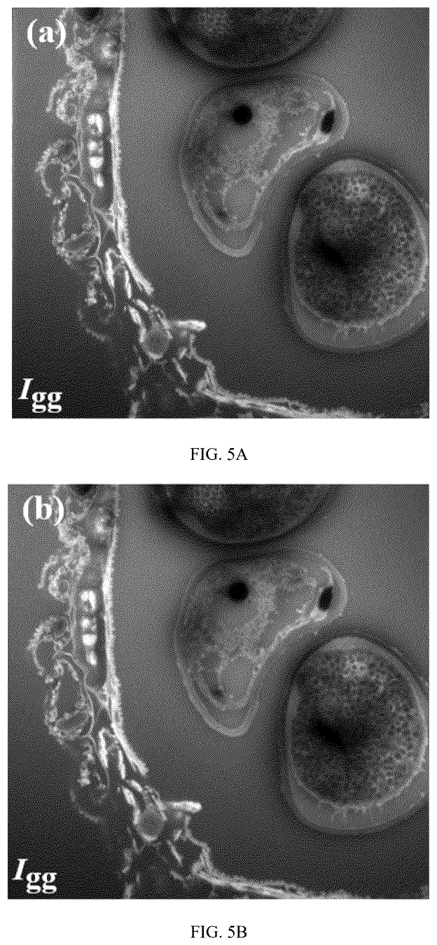

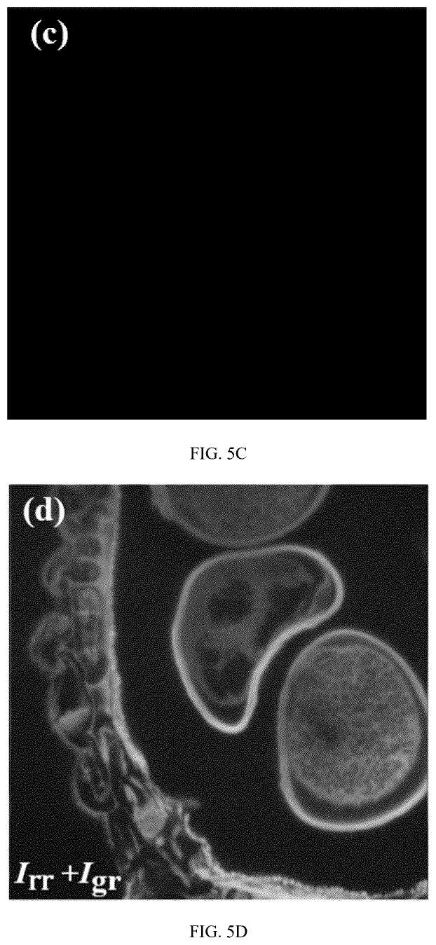

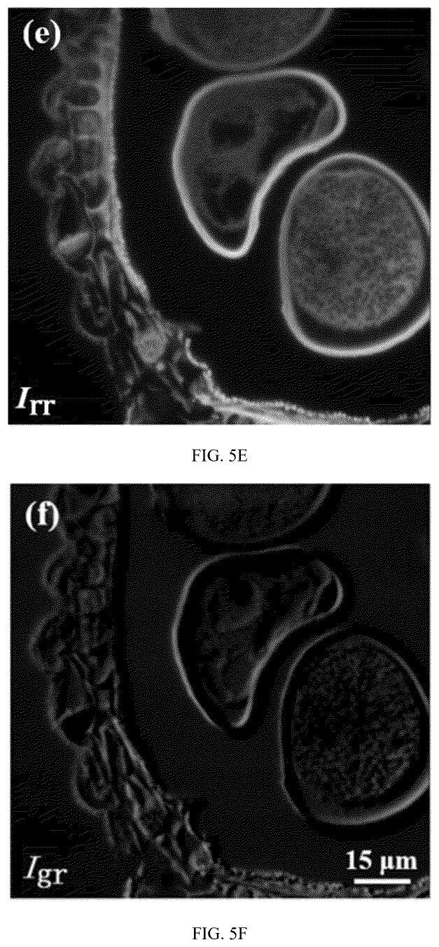

In this example, the to-be-tested sample 14 is wheat anther, and dual-channel synchronous imaging results for this sample under the excitation of laser with wavelengths of 470 nm and 561 nm are shown in FIG. 5A through FIG. 5F. FIG. 5A and FIG. 5B show gray images of confocal scanning fluorescence imaging of the wheat anther under the excitation of laser with wavelength of 470 nm with and without the introduction of pulse interleaved excitation, respectively. The contribution of fluorescence signal intensity in FIG. 5A and FIG. 5B comes from the signal Igg excited by the laser with the wavelength of 470 nm and collected by the green acquisition channel. FIG. 5C shows a gray image of a difference between the gray images in FIG. 5A and FIG. 5B, that is, a gray value of each pixel in FIG. 5A is subtracted from a gray value of a corresponding pixel in FIG. 5B. From FIG. 5C, it can be seen that there is no crosstalk influence in the green acquisition channel. FIG. 5D and FIG. 5E show gray images of confocal scanning fluorescence imaging of the wheat anther under the excitation of laser with wavelength of 561 nm with and without the introduction of pulse interleaved excitation, respectively. The contribution of fluorescence signal in FIG. 5D comes from the signal Igr+Irr which is simultaneously excited by two laser with two wavelengths and collected by the red acquisition channel. The contribution of the fluorescence signal in FIG. 5E mainly comes from the signal Irr excited by the laser with the wavelength of 561 nm and collected by the red acquisition channel. FIG. 5F shows a gray image of a difference between the gray images in FIG. 5D and FIG. 5E. From FIG. 5F, it can be seen that there is an obvious crosstalk signal Igr, which shows that the color crosstalk caused by the shorter wavelength laser in the longer wavelength channel can be significantly suppressed after the pulse interleaved excitation is performed.

To sum up, the idea of color crosstalk-removed bicolor synchronous imaging in the disclosure is as follows. Firstly, according to the working wavelengths of the used two laser, the appropriate filters are selected in the two acquisition channels respectively. By the control and reconstruction module, the illumination module can emit dual-wavelength parallel laser beams, the dual-wavelength parallel laser beams are two parallel laser beams with different wavelengths, and laser pulses of one of the two parallel laser beams are interleaved with laser pulses of the other one of the two parallel laser beams. On the other hand, the scanning-imaging module can be controlled to realize point-by-point excitation and collection of fluorescence signals in a sample area. The collected fluorescence signals and stray optical signals in the scanning-imaging module are reflected to the first dichroic mirror, and the fluorescence signals and the stray optical signals are transmitted into the acquisition module because the transmission conditions of the first dichroic mirror are satisfied. The second dichroic mirror in the acquisition module separates these optical signals (i.e., the fluorescence signals and the stray optical signals) into two branches: the red acquisition channel and the green acquisition channel according to the wavelength range. After the stray light (i.e., the optical signals) is filtered by the corresponding optical filter in each branch, the fluorescence signals of two branch are finally received by two avalanche photodiode detectors.

It should be noted that the key of color crosstalk-removed bicolor synchronous imaging lies in two means: pulse interleaved excitation and time-correlated single photon technology. The realization of pulse interleaved excitation first needs to generate a digital delay signal (i.e., the digital signal containing delay information) through a function generator of the host computer, and the digital delay signal is converted into an electrical signal through digital-to-analog conversion and sent to a data acquisition card. The electrical signal is distributed to a delay signal generator, and is then converted into an electrical signal that can be recognized by a laser module and is sent to a laser module, so that one of the two laser in a working state of the laser module emits a laser pulse with a certain delay relative to other laser pulse from the other of the two laser. On the other hand, the time-correlated single photon counting device is used to convert the optical signal obtained by the acquisition module into a statistical result of photon data in time domain, and the fluorescence signals of different wavelengths are separated by reconstructing the photon data, and the two-color synchronous imaging with color crosstalk removed is completed by combining spatial information.

The dual-channel laser confocal microscope system of the disclosure can separate the laser beams with different wavelengths from each other in a time domain, that is, under the condition that a main frequency of pulses of two pulsed laser is fixed, by introducing a certain time delay to one of the two pulsed laser, and separating and counting collected single photon data in a time channel, the color crosstalk that occurs when a fluorescence signal excited by the short-wavelength laser is in an excitation wavelength region of the long-wavelength fluorescent substance can be effectively avoided, thus further ensuring the accuracy and reliability of the synchronous imaging results of dual-color confocal scanning. Compared with the traditional confocal microscope system, two kinds of subcellular organelles labeled with different fluorescent markers can be photographed at the same time, which has faster imaging speed and provides a powerful means for studying the interaction between different subcellular organelles.

From several embodiments provided by the disclosure, it should be understood that the devices and methods disclosed by the disclosure can be realized in other ways. For example, the device embodiment described above is only schematic. For example, the division of the modules is only a logical function division. In actual implementation, there may be another division method, for example, multiple modules or components can be combined or integrated into another system, or some features can be ignored or not implemented.

In addition, each functional module in each embodiment of the disclosure may be integrated into one processing module, or each module may exist physically alone, or two or more modules may be integrated into one module. The above-mentioned integrated modules can be realized in the form of hardware, or in the form of hardware plus software functional modules.

The above is a further detailed description of the disclosure in combination with specific preferred embodiments, and it cannot be considered that the specific implementation of the disclosure is limited to these descriptions. For ordinary technicians in the technical field to which the disclosure belongs, several simple deductions or substitutions can be made without departing from the concept of the disclosure, all of which should be regarded as belonging to the protection scope of the disclosure.

What is claimed is:

1. A dual-channel laser confocal microscope system for crosstalk elimination, comprising an illumination module (101), a scanning-imaging module (102), an acquisition module (103) and a control and reconstruction module (104);
wherein the illumination module (101), the scanning-imaging module (102) and the acquisition module (103) are sequentially coupled and connected in that order to form an optical system;
wherein the illumination module (101) is configured to emit dual-wavelength parallel laser beams under control of the control and reconstruction module (104), the dual-wavelength parallel laser beams are two parallel laser beams with different wavelengths, and laser pulses of one of the two parallel laser beams are interleaved with laser pulses of the other one of the two parallel laser beams;
wherein the scanning-imaging module (102) is configured to: make both of the dual-wavelength parallel laser beams move in two orthogonal directions, converge the dual-wavelength parallel laser beams on a to-be-tested sample (14), perform point-by-point scanning on the to-be-tested sample (14) to excite fluorescence signals from the to-be-tested sample (14), and collect the fluorescence signals; and the fluorescence signals have two different bandwidths on wavelength;
wherein the acquisition module (103) is configured to separate the fluorescence signals into different acquisition channels of the acquisition module (103), respectively, the different acquisition channels are configured to: filter out excitation laser in the different acquisition channels to obtain the fluorescence signals, and eventually convert the fluorescence signals into electrical signals;
wherein the control and reconstruction module (104) is configured to: generate two electronic pulse trains to control the illumination module (101) to interleavely emit the laser pulses of the two parallel laser beams; regulate a scanning range and a scanning speed of the scanning-imaging module (102), and decouple and reconstruct the fluorescence signals in the different acquisition channels of the acquisition module (103) to obtain confocal images without crosstalk for the different wavelengths, and wherein the illumination module (101) is further configured to recognize the two electronic pulse trains.

2. The dual-channel laser confocal microscope system for crosstalk elimination as claimed in claim 1, wherein the control and reconstruction module (104) comprise a host computer (1), a data acquisition card (2), a delay signal generator (3) and a time-correlated single photon counting (TCSPC) device (29);
wherein the host computer (1) is configured to generate a digital signal containing delay information and transmit the digital signal containing the delay information to the data acquisition card (2);
wherein the data acquisition card (2) is configured to transmit the digital signal containing the delay information to the delay signal generator (3);
wherein the delay signal generator (3) is configured to generate a delay signal based on the digital signal containing the delay information and transmit the delay signal to the illumination module (101);
wherein the TCSPC device (29) is configured to: record a total number of photons of the fluorescence signals and record absolute time and relative time of each of the photons, wherein the absolute time represents the incoming time of the photon relative to operating time in one measurement of the dual-channel laser confocal microscope system, and the relative time represents a time lag of the photon with the laser pulse previous to the photon; and
wherein the host computer (1) is further configured to: perform statistics on the time lag of each photon, to thereby yield fluorescence decay curves for each pixel in the different acquisition channels; separate the fluorescence decay curves in time series based on the different wavelengths; and reconstruct the confocal images without crosstalk for the different wavelengths.

3. The dual-channel laser confocal microscope system for crosstalk elimination as claimed in claim 2, wherein the illumination module (101) comprises a laser module (4), a first single-mode optical fiber (5), a first collimating lens (6), a first reflector (7) and a first dichroic mirror (8), which are sequentially arranged along a beam transmission direction of the illumination module (101);
wherein the laser module (4) is connected with the delay signal generator (3) and is configured to emit dual-wavelength laser beams under control of the delay signal generator (3), and laser pulses of one of the dual-wavelength laser beams are interleaved with laser pulses of the other of the dual-wavelength laser beams;
wherein the first single-mode optical fiber (5) is configured to couple the dual-wavelength laser beams to obtain coupled dual-wavelength laser beams;
wherein the first collimating lens (6) is configured to collimate the coupled dual-wavelength laser beams to obtain collimated laser beams; and
wherein the first reflector (7) and the first dichroic mirror (8) are configured to reflect the collimated laser beams to the scanning-imaging module (102) to thereby obtain the dual-wavelength parallel laser beams.

4. The dual-channel laser confocal microscope system for crosstalk elimination as claimed in claim 3, wherein the scanning-imaging module (102) comprises a scanning galvanometer (9), a scanning lens (10), a second collimating lens (11), a second reflector (12) and an objective lens (13), which are sequentially arranged along a beam transmission direction of the scanning-imaging module (102);
wherein the scanning galvanometer (9) is connected with the data acquisition card (2), and is configured to receive the digital signal from the data acquisition card (2), and scan the dual-wavelength parallel laser beams from the illumination module (101) in the two orthogonal directions;
wherein the scanning galvanometer (9) comprises two sub-reflectors arranged in parallel, and the two sub-reflectors are configured to rotate under action of the digital signal to make both of the dual-wavelength parallel laser beams move in the two orthogonal directions under rotation of the two sub-reflectors;
wherein the scanning lens (10) and the second collimating lens (11) construct a telescope configuration, and the telescope configuration is configured to expand the dual-wavelength parallel laser beams from the scanning galvanometer (9) to obtain expanded dual-wavelength parallel laser beams;
wherein the second reflector (12) is configured to reflect the expanded dual-wavelength parallel laser beams emitted by the second collimating lens (11) to the objective lens (13), the objective lens (13) is configured to: converge the expanded dual-wavelength parallel laser beams on the to-be-tested sample (14), to scan the to-be-tested sample (14) point by point and thereby to excite the fluorescence signals from the to-be-tested sample (14); and collect the fluorescence signals; and
wherein an entrance pupil position of the scanning galvanometer (9) is imaged to an entrance pupil position of the objective lens (13) via the telescope configuration.

5. The dual-channel laser confocal microscope system for crosstalk elimination as claimed in claim 4, wherein wavelengths of the collimated laser beams are in a reflection band-pass wavelength range of the first dichroic mirror (8), and the collimated laser beams are reflected on to the first dichroic mirror (8); and
wherein a wavelength range of the fluorescence signals from the to-be-tested sample (14) returned from the scanning-imaging module (102) is not in the reflection band-pass wavelength range of the first dichroic mirror (8), and the fluorescence signals from the to-be-tested sample (14) are transmitted from the first dichroic mirror (8) to the acquisition module (103).

6. The dual-channel laser confocal microscope system for crosstalk elimination as claimed in claim 4, wherein the acquisition module (103) comprises a second dichroic mirror (15), a red acquisition channel and a green acquisition channel;
wherein the second dichroic mirror (15) is disposed at a side of the first dichroic mirror (8) facing away from the scanning galvanometer (9); and the second dichroic mirror (15) is configured to receive the fluorescence signals from the to-be-tested sample (14) collected by the objective lens (13), and separate the fluorescence signals into a first wavelength fluorescence signal and a second wavelength fluorescence signal;
wherein the red acquisition channel is disposed in a transmission direction of the second dichroic mirror (15), and is configured to receive the first wavelength fluorescence signal and convert the first wavelength fluorescence signal into a first electrical signal;
wherein the green acquisition channel is disposed in a reflection direction of the second dichroic mirror (15), and is configured to receive the second wavelength fluorescence signal and convert the second wavelength fluorescence signal into a second electrical signal; and
wherein a wavelength of the first wavelength fluorescence signal is longer than a wavelength of the second wavelength fluorescence signal.

7. The dual-channel laser confocal microscope system for crosstalk elimination as claimed in claim 6, wherein the red acquisition channel comprises a third reflector (16), a fourth reflector (17), a first adjustable optical filter (18), a first condenser lens (19), a second single-mode optical fiber (20) and a first detector (21), which are sequentially arranged along the transmission direction of the second dichroic mirror (15);
wherein the first adjustable optical filter (18) is configured to filter out the excitation laser in the red acquisition channel; and
wherein the first detector (21) is configured to receive the first wavelength fluorescence signal in the red acquisition channel, convert the first wavelength fluorescence signal in the red acquisition channel into the first electrical signal, and transmit the first electrical signal to the host computer (1).

8. The dual-channel laser confocal microscope system for crosstalk elimination as claimed in claim 6, wherein the green acquisition channel comprises a fifth reflector (22), a sixth reflector (23), a seventh reflector (24), a second adjustable optical filter (25), a second condenser lens (26), a third single-mode optical fiber (27) and a second detector (28), which are sequentially arranged along the reflection direction of the second dichroic mirror (15);
wherein the second adjustable optical filter (25) is configured to filter out the excitation laser in the green acquisition channel; and
wherein the second detector (28) is configured to receive the second wavelength fluorescence signal in the green acquisition channel, convert the second wavelength fluorescence signal in the green acquisition channel into the second electrical signal, and transmit the second electrical signal to the host computer (1).
